(19) United States
(12) Patent Application Publication
(10) Pub. No.: US 2024/0371562 A1
(43) Pub. Date: Nov. 7, 2024

(54) COOLING ARRANGEMENT AND METHOD FOR COOLING AT LEAST ONE OIL-TO-AIR EXTERNAL HEAT EXCHANGER

(71) Applicant: Hitachi Energy Ltd, Zürich (CH)

(72) Inventors: Ener SALINAS, Västerås (SE); Ulf SAND, Västerås (SE); Kiran Chandra SAHU, Västerås (SE); Samuel BRODEUR, St-Bruno (CA)

(21) Appl. No.: 18/688,814

(22) PCT Filed: Sep. 1, 2022
(86) PCT No.: PCT/EP2022/074303

§ 371 Date: Mar. 4, 2024

(30) Foreign Application Priority Data
Sep. 6, 2021 (EP) 21195088.6

(51) Int. Cl. H01F 27/12; H05K 7/20

(52) U.S. Cl. CPC H01F 27/12; H05K 7/209

(57) ABSTRACT

A cooling arrangement for cooling at least one OAEHE in a transformer. The cooling arrangement includes at least one impeller-motor device, at least one fluid pipe at least one fluid discharge device. The at least one impeller-motor device is adapted to supply a fluid to the inlet of the at least one fluid discharge device via the at least one fluid pipe and cause the fluid to flow through the at least one fluid discharge device and be discharged through the at least one fluid outlet of the at least one fluid discharge device. The cooling arrangement further comprises includes a funnel. The at least one impeller-motor device is located in a housing at a distance of at least 3 meters from the at least one fluid discharge device.

### CROSS REFERENCE TO RELATED APPLICATIONS

This application is a 35 U.S.C. § 371 national stage application of PCT International Application No. PCT/EP2022/074303 filed on Sep. 1, 2022, which in turn claims foreign priority to European Patent Application No. 21195088.6, filed on Sep. 6, 2021, the disclosures and content of which are incorporated by reference herein in their entirety.

### FIELD OF THE DISCLOSURE

The disclosure relates to the field of transformers. In particular, the disclosure relates to a cooling arrangement for cooling at least one oil-to-air external heat exchanger (OAEHE) in a transformer.

### BACKGROUND

A power transformer is equipment used in an electric grid of a power system. Power transformers transform voltage and current in order to transport and distribute electric energy.

Power transformers involve high currents; therefore, production of heat is inevitable. This heat propagates in the oil inside the transformer tank. It is important to release this heat to the surroundings for the normal operation of transformers. An important part of oil-cooling is carried out by placing external devices, such as radiators, coolers etc., through which the transformer oil is circulated and get cooled. State-of-the art air-cooling for a transformer is performed using conventional fans, i.e., bladed fans, or natural convection. For high power rated transformers, natural convection is not enough, and therefore, forced cooling is needed for this operation. When water is available, water cooling may be employed. Coolers are utilized in approximately 10% of power transformers, approximately 5% require fans. Utilization of water and air cooling, using fans, comprise of only 1%. Approximately 90% of power transformers may utilize radiators. In large power transformers, fans may also be needed to handle over-rating situations. In conclusion, approximately 95% of power transformers may incorporate fans for cooling in their design.

Due to the heating of power transformers and installation of external cooling equipment, ambient air may be brought to cool these devices, which work with natural or forced convection principles. This air should be of required speed and in large quantities, i.e., of high airflow rate. External cooling equipment should preferably not disturb the environment nor the surroundings, by e.g., noise or vibration. It should also be capable to operate in a harsh environment, of e.g., −40° C. to +60° C.

Currently, standard fans are the state-of-the-art solution to cool down power transformers. The main reason behind this is that it is a well-known technology. Similar techniques are being used in air conditioning for homes and large buildings, as well as cooling for industrial facilities and data centres, etc.

Yet, implementing standard fans in power transformers external cooling pose some issues, such as:
Complexity: the motor of the fan is attached to blades, and both are inside a metal cage; in addition to this, many electrical cables are necessary to energize the motor.
Hard to increase the cooling airflow rate due to fans characteristic performance curves.
Poor scalability: increasing blade size increases quadratically the moment of inertia.
Difficult, time consuming and costly maintenance as cumbersome to access the blades and/or the motor.
Fans are noisy, e.g., around ˜70 dB, and the cost of mitigation is high, legal issues can emerge.
Fans are rather heavy, in the order of 5 kg/piece.
High security risks as it is easy to sabotage cooling fans.
Weather sensitive, e.g., when located close to the coast.

The present disclosure presents an improved viable solution of a cooling arrangement.

### SUMMARY

It is an object of embodiments herein to enhance cooling of an OAEHE of a transformer, or at least to achieve an alternative to known solutions within the technical field.

According to an aspect the object is achieved by providing a cooling arrangement for cooling at least one OAEHE in a transformer. The cooling arrangement comprises at least one impeller-motor device, at least one fluid pipe, and at least one fluid discharge device. The at least one fluid discharge device comprises a fluid inlet for receiving fluid from the at least one fluid pipe and at least one fluid outlet arranged to direct a fluid flow towards the at least one OAEHE. The at least one impeller-motor device is adapted to supply a fluid to the inlet of the at least one fluid discharge device via the at least one fluid pipe and cause the fluid to flow through the at least one fluid discharge device and be discharged through the at least one fluid outlet of the at least one fluid discharge device. The cooling arrangement further comprises a funnel. The at least one impeller-motor device is located in a housing at a distance of at least 3 meters from the at least one fluid discharge device.

According to another aspect the above-mentioned object is also achieved by providing a method performed by a cooling arrangement for cooling at least one OAEHE in a transformer. The cooling arrangement comprises at least one impeller-motor device, at least one fluid pipe and at least one fluid discharge device. The at least one fluid discharge device comprises a fluid inlet for receiving fluid from the at least one fluid pipe and at least one fluid outlet. The cooling arrangement supplies a fluid flow into the at least one fluid pipe, using the at least one impeller-motor device. The cooling arrangement further transports the fluid flow along the at least one fluid pipe to the inlet of the at least one fluid discharge device. The cooling arrangement further causes the fluid to flow through the at least one fluid discharge device. The cooling arrangement then further discharges the fluid flow through the at least one fluid outlet in a direction of the at least one OAEHE. The cooling arrangement further comprises a funnel. The at least one impeller is located in a housing at a distance of at least 3 meters from the at least one fluid discharge device.

Embodiments herein are based on the realisation that by providing a cooling arrangement comprising at least one fluid discharge device, at least one fluid pipe, at least one funnel and at least one impeller-motor device located in a housing at a distance of at least 3 meters from the at least one fluid discharge device, the cooling arrangement can utilize the surrounding fluid to increase the fluid flow that is transported to the fluid discharge device. Thereby the cooling arrangement effectively provides a powerful and enhanced fluid flow to at least one OAEHE of a transformer.

### BRIEF DESCRIPTION OF THE FIGURES

Further technical features of the disclosure will become apparent through the following description of one or several exemplary embodiments given with reference to the appended figures, where:

FIG. 1 is a schematic overview depicting a cooling arrangement based on a Bernoulli principle according to embodiments herein;

FIG. 2 is a schematic overview depicting a cooling arrangement, according to embodiments herein;

FIG. 3 is a schematic overview depicting a fluid discharge device cross-section;

FIG. 4 is a schematic overview depicting a fluid discharge device with a hose, in accordance with some embodiments;

FIG. 5 is a flowchart depicting a method performed by a cooling arrangement according to embodiments herein;

FIGS. 6a-f are schematic overviews depicting a cooling arrangement applied to a radiator or cooled group, external to a tank of a large power transformer, in accordance with some embodiments;

FIG. 7 is a diagram depicting an example of an outlet volume flow rate in function of an inlet volume flow rate for various fluid discharge device diameter;

FIG. 8 is a schematic overview depicting fluid discharge devices with different fluid flow rates, A, B and C; and

FIGS. 9a-b illustrate schematic overviews according to some embodiments.

It should be noted that the drawings have not necessarily been drawn to scale and that the dimensions of certain elements may have been exaggerated for the sake of clarity.

### DETAILED DESCRIPTION

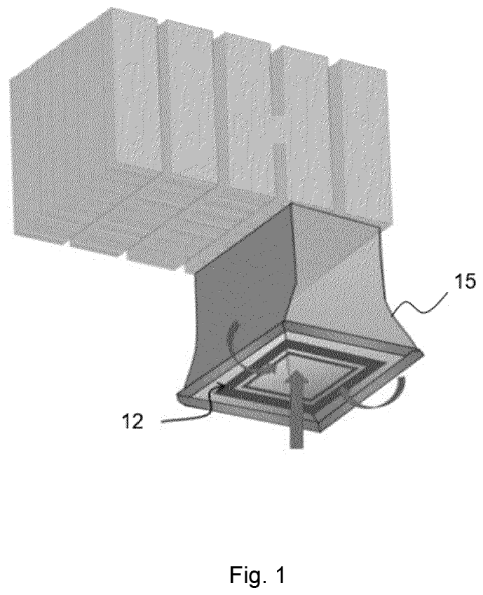

Parts of a cooling arrangement 20 according to some embodiments is illustrated in FIG. 1. The cooling arrangement 20 is based on the Bernoulli principle and comprises that a fluid flow, e.g., airflow, for a fluid discharge device 12, e.g., an emitter ring, has been generated in a generating room, e.g., a chamber or a housing which may be sound shielded. The fluid flow is then transported to the fluid discharge device 12. The fluid flow leaves the fluid discharge device 12 by an outlet, which may be a narrow slit, at high-speed producing low pressure. This will by induction and entrainment, i.e., the Bernoulli effect, which attracts air from the surroundings, multiply the initial fluid flow by 10 to 50 times, depending on the geometry and dimensions of the fluid discharge device 12. The fluid discharge device 12 has no electrical connections and the fluid flow is generated in a generating room. FIG. 1 also shows a funnel 15, e.g., a funnel duct with Coanda border to enhance the fluid flow. An OAEHE is shown in FIG. 1 in the form of a radiator.

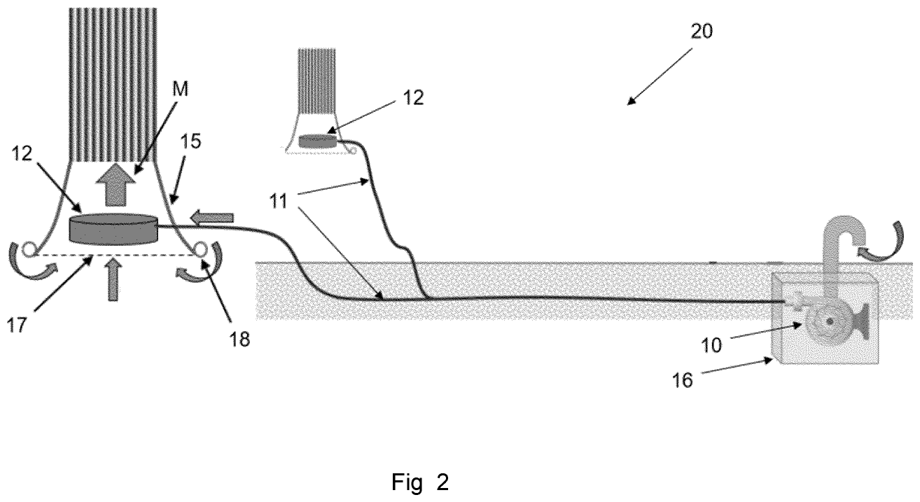

An integrated description and operation of the cooling arrangement 20 according to embodiments herein is illustrated in FIG. 2. The cooling arrangement 20 comprises at least one impeller-motor device 10, at least one fluid pipe 11 and the at least one fluid discharge device 12. The at least one fluid discharge device 12 may be hollow and comprises a fluid inlet, for receiving fluid from the at least one fluid pipe 11, and at least one fluid outlet, arranged to direct a fluid flow towards at least one OAEHE. The cooling arrangement 20 further comprises a funnel 15. The operation of the cooling arrangement 20 comprises:
1. A generated fluid flow may be brought to the impeller-motor device 10. The fluid flow may be filtered through a filter before being brought to the impeller-motor device 10.
2. The impeller-motor device 10 then supplies, e.g., accelerates, the fluid flow to the fluid pipe 11. The fluid pipe 11 may comprise a thermally insulated material. The impeller-motor device 10 is located in a housing 16 at a distance from the at least one fluid discharge device 12. This distance between the impeller-motor device 10 and the at least one fluid discharge device 12 may be of at least 1 meter, 3 meters, 5 meters or more. This distance between the impeller-motor device 10 and the at least one fluid discharge device 12 is advantageous, e.g. because sound from the impeller-motor device will be generated far away from the transformer making sound mitigation procedures possible, e.g., sound-shielded housing 16 and reduced sound fluid pipes 11. By transferring the origin of sound to the sound-shielded housing, the fluid discharge device 12 operation may become sound reduced by 20 to 40 dB as compared to conventional bladed fans. The housing 16 may be sound shielded, thermally insulated, may comprise thermally insulating material, may be humidity controlled, may be dustproof and/or sound absorbing. The housing 16 and the at least one fluid pipe 11 may be located underground or covered by a strong structure, which can reduce the risk of vandalism and intentional attacks to the transformer plant. According to some embodiments, the cooling arrangement 20 may comprise a plurality of fluid pipes 11 that are adapted to supply fluid to a plurality of fluid discharge devices 12.
3. The fluid flow is transported along the pipe 11 towards the inlet of the fluid discharge device 12 with minimal pressure drop. The fluid discharge device 12 may be arranged, e.g., fixated, in the funnel 15. The funnel 15 may comprise round smooth borders 18 at an inlet of the funnel 15 to facilitate a Coanda effect, which mitigates edge turbulence and reduces pressure drop at the inlet of the funnel 15. The inlet of the funnel 15 may comprise a filter grid 17. The filter grid 17 is used for preventing unwanted objects entering the OAEHE.
4. The fluid flow may be forced to distribute at high pressure inside the fluid discharge device 12.
5. High speed fluid is then discharged, e.g., ejected, through the outlet of the fluid discharge device 12. According to some embodiments the fluid discharge device 12 comprises at least one slit and the fluid may be discharged through the slit which may be narrow, e.g., a slit that is designed to induce the flow towards the OAEHE.
6. Due to the high-speed fluid, fluid in the back of the fluid discharge device 12 is induced into the central region of the fluid discharge device 12. And nearby the outlet of the fluid discharge device 12, fluid is entrained. The induction and entrainment, i.e., the Bernoulli effect, may multiply the initial fluid flow M by 10 to 50 times depending on the geometry and dimensions of the fluid discharge device 12.
7. The aerodynamics shape of the toroid-like surface of the fluid discharge device 12 and the Coanda effect enables the fluid flow to be directed towards the OAEHE.
8. Additional fluid flow may be added to the axial region of the fluid discharge device 12 with a hose 21 or a second fluid discharge device which is smaller than the fluid discharge device 12. I.e., the maximum cross-sectional dimension of the second fluid discharge device is smaller than the maximum cross-sectional dimension of the first fluid discharge device 12, to enhance and homogenize the discharged, e.g., emitted, fluid flow.
9. The obtained fluid flow may be increased to match the requirements to cool the at least one OAEHE in a transformer. A set of parameters may provide such a dedicated design.

### These Parameters are:

a. Impeller-motor device power;
b. Fluid discharge device diameter and/or size;
c. Slit thickness;
d. Toroid-like shape of the fluid discharge device 12 and cross-section dimensions of the fluid discharge device 12. The fluid discharge device 12 may have a cross-section that is circular, oval, rectangular or any other polygonal shape. The fluid outlet of the discharge device 12 follows the outer perimeter of the discharge device 12.
10. High speed fluid passes through the OAEHE, whose geometrical shape will produce a pressure drop. The remaining fluid flow may be utilized to cool down a second or more OAEHEs.

The result of the cooling arrangement 20 operation is the multiplication of the inlet fluid flow, typically by a factor of 10 to 50. The technology of the cooling arrangement 20 utilizes the surrounding fluid to amplify the fluid flow that is transported to the fluid discharge device 12. It is concluded that the cooling arrangement 20 effectively provides a powerful and efficient bulk fluid flow to at least one OAEHE of a transformer.

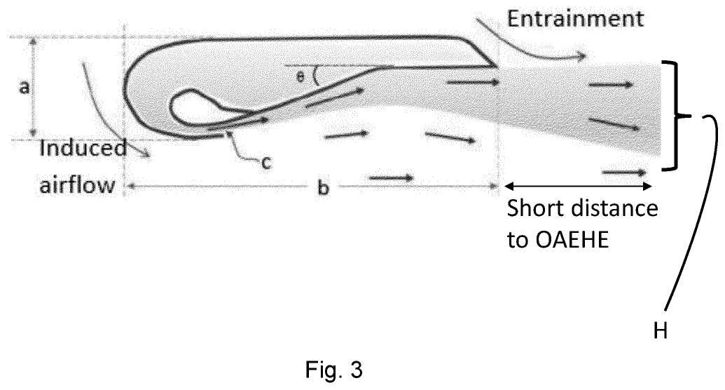

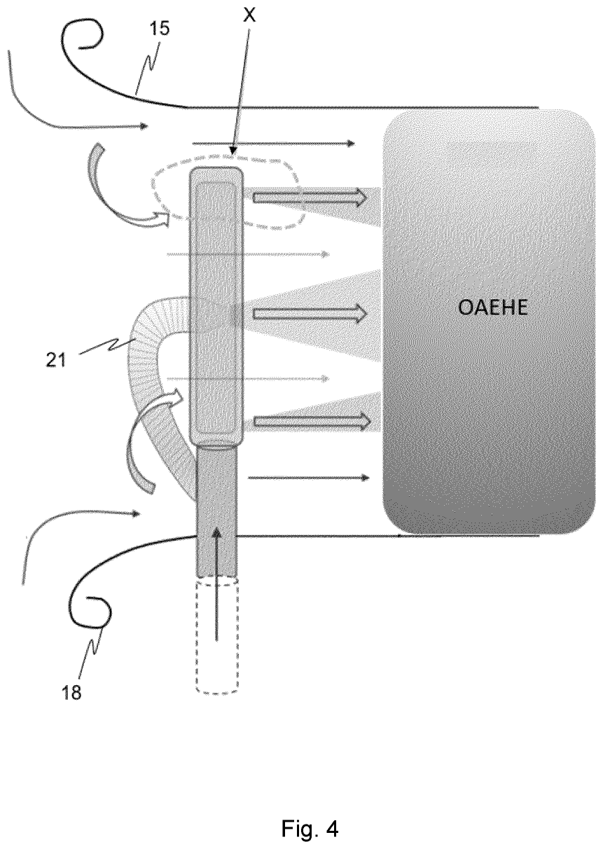

FIG. 3 illustrates the fluid discharge device 12 cross-section. The speed of the fluid flow, e.g., airflow as shown in FIG. 3, at the outlet c of the fluid discharge device 12 is very high, e.g., >15 m/s. The relation of dimensions a, b and 0 may be arranged to try to get a homogeneous fluid flow H in minimal to the OAEHE.

FIG. 4 illustrates the fluid discharge device 12 with an additional hose 21 according to some embodiments herein. The hose 21 may homogenize the fluid flow towards the OAEHE. The edges of the funnel 15 may be curved and comprise round smooth borders 18 instead of sharp to guide and enhance the fluid flow and facilitate a Coandă effect, which mitigates edge turbulence and reduces pressure drop at the inlet of the funnel 15. FIG. 4 further shows the cross-section X of the fluid discharge device 12.

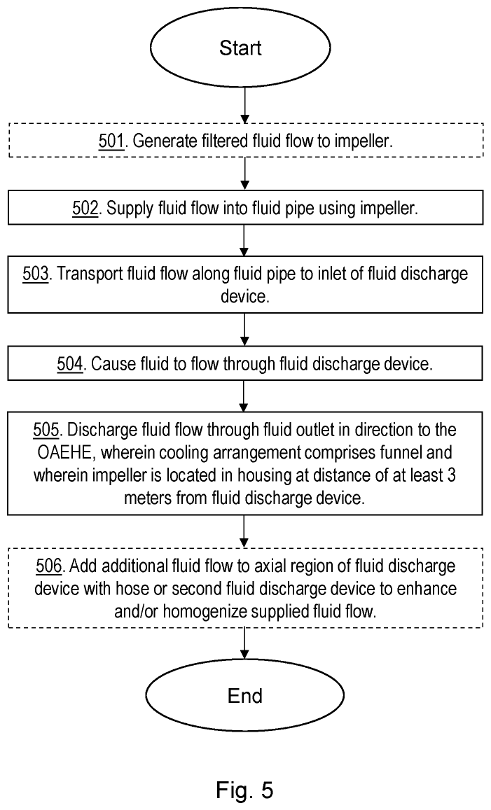

The method actions performed by a cooling arrangement 20 for cooling at least one OAEHE in a transformer, according to embodiments herein, will now be described with reference to a flowchart depicted in FIG. 5. The actions do not have to be taken in the order stated below but may be taken in any suitable order. Actions performed in some embodiments are marked with dashed boxes. The cooling arrangement 20 comprises at least one impeller-motor device 10, at least one fluid pipe 11 and at least one fluid discharge device 12. The fluid discharge device 12 comprises a fluid inlet for receiving fluid from the at least one fluid pipe 11, and at least one fluid outlet.

### Action 501.

The cooling arrangement 20 may generate a filtered fluid flow to the at least one impeller-motor device 10. The filter is to avoid having dust and/or particles into the at least one impeller-motor device 10 and through the at least one fluid pipe 11 and the at least one fluid discharge device 12. The at least one impeller-motor device 10 is located in a housing 16 at a distance of at least 3 meters from the at least one fluid discharge device 12. This separation may transfer the origin of sound to the sound-shielded housing; therefore the fluid discharge device 12 operation becomes sound reduced by 20 to 40 dB as compared to conventional bladed fans. The housing 16 may be one or more of: sound-shielded, thermally insulated, comprises thermally insulating material, humidity controlled, dustproof and/or sound absorbing.

### Action 502.

The cooling arrangement 20 supplies the fluid flow into the at least one fluid pipe 11, using the at least one impeller-motor device 10. The at least one fluid pipe 11 may comprise a thermally insulated material. The cooling arrangement 20 may comprise a plurality of fluid pipes 11 that are adapted to supply fluid to a plurality of fluid discharge devices 12.

### Action 503.

The cooling arrangement 20 transports the fluid flow along the at least one fluid pipe 11 to the inlet of the at least one fluid discharge device 12. The at least one fluid discharge device 12 comprises a cross-section that is circular, oval, rectangular or any other polygonal shape. The fluid outlet of the discharge device 12 follows the outer perimeter of the discharge device 12. The cooling arrangement 20 comprises a funnel 15. The at least one fluid discharge device 12 may be arranged in the funnel 15. The funnel 15 may comprise round smooth borders 18 at an inlet of the funnel 15 to facilitate a Coandă effect, which mitigates edge turbulence and reduces pressure drop at the inlet of the funnel 15.

### Action 504.

The cooling arrangement 20 causes the fluid to flow through the at least one fluid discharge device 12.

### Action 505.

The cooling arrangement 20 discharges, e.g., emits, the fluid flow through the at least one fluid outlet in a direction of the at least one OAEHE. The fluid discharge device 12 may comprise at least one slit that is designed to be so narrow as to alter a recited physical property of the fluid stream by a recited amount due to the Bernoulli effect and the cooling arrangement 20 may discharge the fluid through the slit in the direction of the at least one OAEHE to cool down the OAEHE.

### Action 506.

The cooling arrangement 20 may add additional fluid flow to an axial region of the fluid discharge device 12 with a hose 21 or a second fluid discharge device to enhance and/or homogenize the supplied fluid flow. The second fluid discharge device may be smaller than the fluid discharge device 12. I.e., the maximum cross-sectional dimension of the second fluid discharge device may be smaller than the maximum cross-sectional dimension of the fluid discharge device 12.

According to some embodiments, the cooling arrangement may comprise a visual device to verify the function of the at least one fluid discharge device 12. The visual device may be useful e.g., if the fluid discharge device 12 gets clogged.

Consequently, embodiments herein thus provide the cooling arrangement 20 comprising the at least one connected impeller-motor device 10, fluid pipe 11 and fluid discharge device 12 ejecting a powerful fluid flow. The impeller-motor device 10 is located inside a housing 16 which may be protective and sound-shielded, and/or may be a thermally insulated, humidity controlled, dustproof and sound absorbing chamber. The fluid pipe 11 may be made of a robust and thermally insulating material. Examples of robust and thermally insulated materials are polymer composites which may include reinforcement such as carbon fibre. For robustness the fluid pipe 11 may also be made of metal covered by concrete. The fluid discharge device 12 has a cross-section that is circular, oval, rectangular or any other polygonal shape. The fluid outlet of the discharge device 12 follows the outer perimeter of the discharge device 12. The fluid discharge device 12 outlet May comprise a narrow slit, where fluid exits and points towards the device to be cooled.

Table 1, the cooling arrangement 20 solves the issues posed by applying the state-of-the-art solution.

| Characteristic | State-of-the-art | Cooling arrangement 20 |
|---|---|---|
| Complexity | The motor, blades and | Simplicity: a single fluid |
| | electrical connections are | discharge device 12, e.g., |
| | inside a metal cage | a ring, made from robust |
| | | material and the impeller- |
| | | motor device 10 are |
| | | separated |
| Power | Not easy to increase the | In order to increase the |
| scalability | cooling airflow rate due to | cooling capabilities, it is |
| | fans characteristic curves | enough to increase the |
| | | input power of the |
| | | impeller-motor device 10 |
| Size scalability | Not good scalability: | Easily scalable to fulfil the |
| | increasing blade size | necessary requirements |
| | increases quadratically | by geometrical parameter |
| | the moment of inertia | variation |
| Noise | Sound power is around 70 | Reduced noise (around 40 |
| | dB and cost of mitigation | dB), only source is the |
| | is high | narrow aperture |
| Weight | (~5 kg per piece), with the | Very light (<1 kg) |
| | need of strong support | |
| | frame | |
| Moment of | High, it may introduce | No moving parts |
| inertia and | imbalance and vibration | |
| dynamics | | |
| Maintenance | Cleaning of dusty blades | Easy to maintain |
| | and motor is difficult and | |
| | time consuming | |
| Reliability | It involves moving parts, | No moving parts and the |
| | multiple assemblies, | impeller-motor device 10 |
| | motor housing openings, | is placed in a protective |
| | dust precipitation on | housing to minimize |
| | blades, there-fore, wear | environmental impacts |
| | and tear reduces lifetime. | |
| Security risks | High security risks (easy | The fluid discharge device |
| | to sabotage on cooling | 12 is robust and the |
| | fans) | impeller-motor device 10 |
| | | may be well-protected |
| | | under the ground |
| Climate | Weather sensitive (e.g., | The fluid discharge device |
| induced | close to the coast) | 12 is highly weather |
| limitations | | resistant, and the impeller- |
| | | motor device 10 may be |
| | | isolated from weather |
| Emitter and | Various problems could | The impeller-motor device |
| generator prone | affect one of them and | 10 can be separated from |
| to concurrent | transmit the issue the | the fluid discharge device |
| issues | other component | 12 making it possible to |
| | | achieve beneficial actions |
| | | such as sound isolation |
| | | coming from the impeller- |
| | | motor device 10 |

Embodiments herein provide external cooling to large power transformers. The state-of-the-art method of using standard fans produces high noise, has complex structure, is heavy and of difficult maintenance. The proposed cooling arrangement 20 is simple, lightweight, and easy to maintain. It is also silent as it has no moving parts at the cooling site. The latter is possible due to the separation of the fluid discharge device 12 from the impeller-motor device 10 which is confined in a housing which may be sound-shielded. Embodiments herein are based on the Bernoulli principle, which makes it possible to multiply by more than one order of magnitude of the inlet fluid flow rate provided by the impeller-motor device 10.

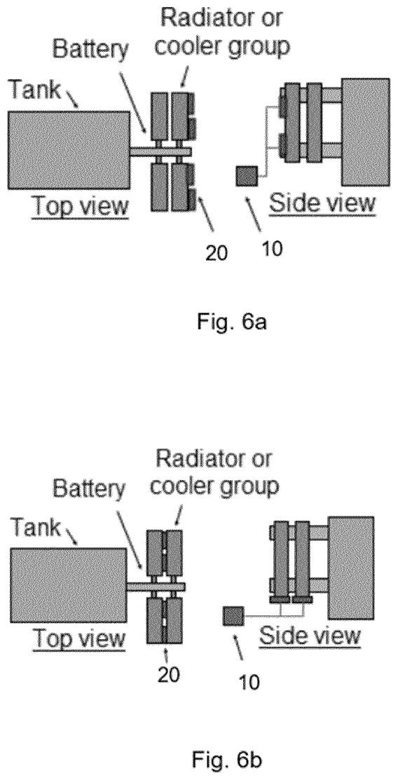

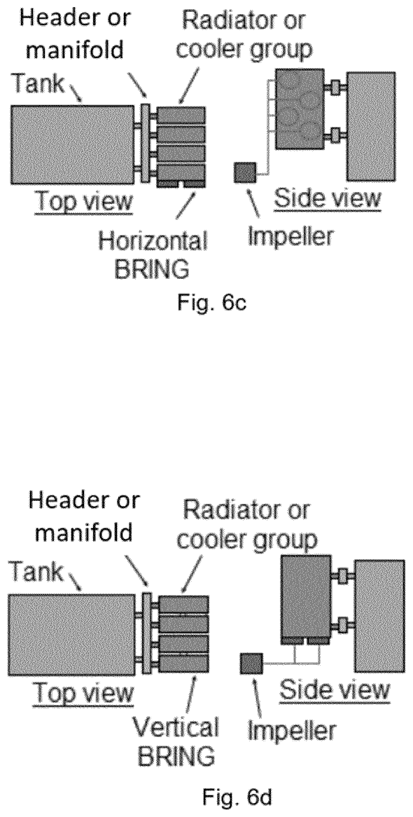

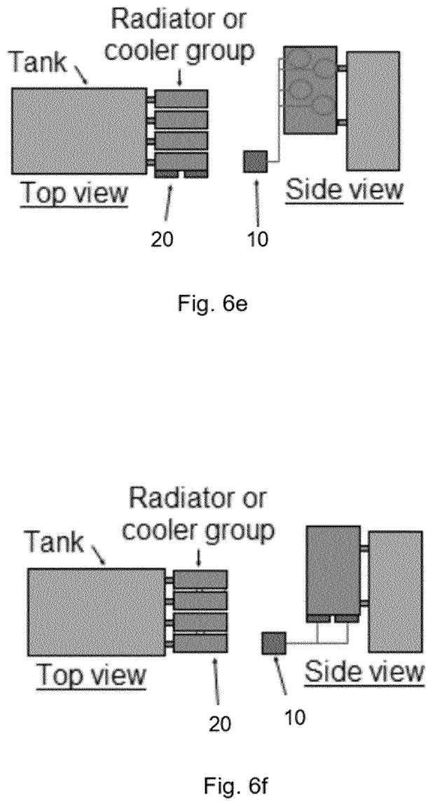

FIGS. 6a-f illustrate schematic overviews according to some embodiments, showing various possible embodiments when applying the cooling arrangement 20 to the OAEHE, e.g., a radiator or cooled group, external to a tank of a large power transformer. FIG. 6a shows a radiator on battery with a horizontal cooling arrangement 20. FIG. 6b shows a radiator on battery with a vertical cooling arrangement 20. FIG. 6c shows a radiator on a header with a horizontal cooling arrangement 20. FIG. 6d shows a radiator on a header with a vertical cooling arrangement 20. FIG. 6e shows a radiator on a tank with a horizontal cooling arrangement 20. FIG. 6f shows a radiator on a tank with a vertical cooling arrangement 20.

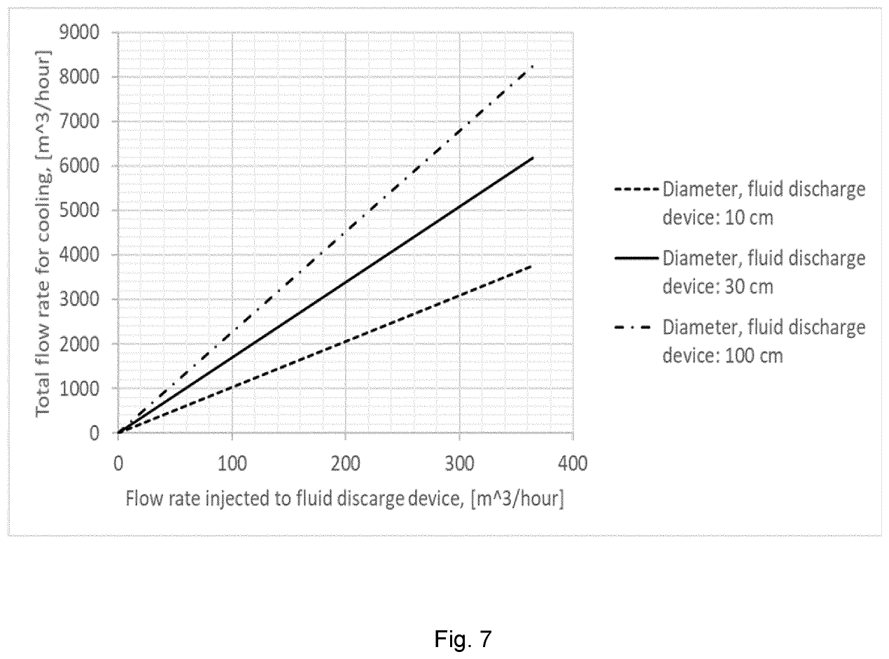

FIG. 7. illustrates a diagram according to some embodiments, wherein the outlet volume flow rate in function of the inlet volume flow rate for various fluid discharge device 12 sizes. The large numbers on the vertical axis indicate that large fluid discharge devices 12 provides very good cooling flow rates.

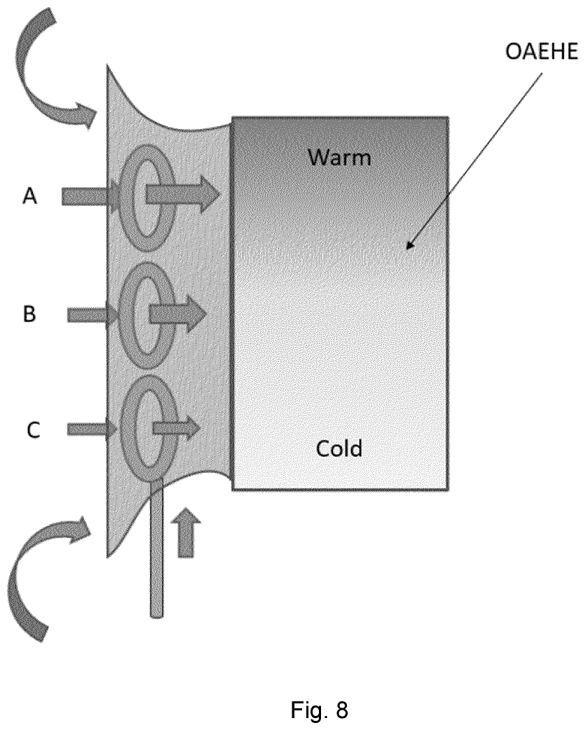

FIG. 8. illustrates a schematic overview according to some embodiments, showing three cooling fluid discharge devices 12 with different airflow rates A, B, C. Since the upper part of the OAEHE is hotter than the lower part, it is possible to design the fluid pipes 11 to give more fluid flow to the upper fluid discharge device 12, e.g., upper ring. According to some embodiments it may be possible to use three interconnected fluid discharge device 12. To avoid high pressure-drop, the fluid pipe 11 transitions may be smooth.

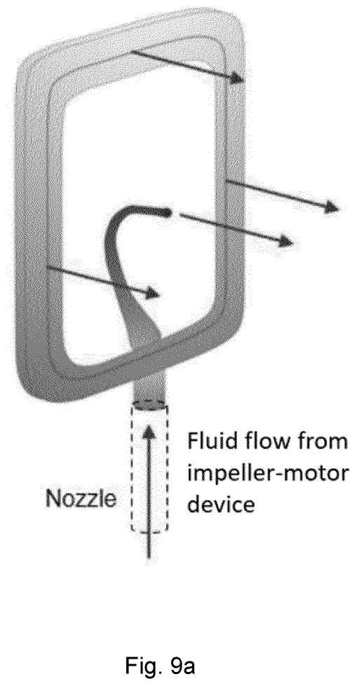

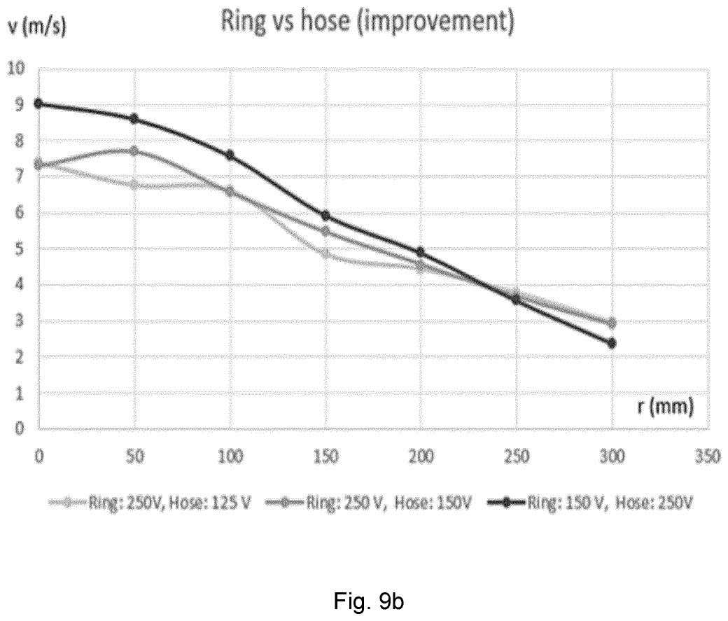

FIG. 9a. illustrates a schematic overview according to some embodiments, wherein one way to compensate the fluid flow in the central region is to split the incoming fluid flow with a sharing to a central hose. (Down left). This has been demonstrated experimentally as shown in the comparative graphs in FIG. 9b.

Advantages and benefits of embodiments herein are:
Size of the fluid discharge device 12 is proportional to the fluid flow rate (flexibility: can be scaled when increased cooling needed).
Input power to the impeller-motor device 10 is proportional to the fluid flow rate (flexibility: can be utilized when increased cooling needed).
Additional hose 21 along the axis of the fluid discharge device 12 can increase the fluid flow rate and flow homogeneity.
Power needed for the cooling arrangement 20 is small as compared to the conventional bladed fans because a multiplication factor would take care of the flow rate needed to cool down OAEHEs.
At a temporary over-rating situation, an extended cooling fluid flow range can be effectively generated if needed.
The cooling arrangement 20 is highly efficient in an outdoor environment.
The impeller-motor device 10 can be separated from the fluid discharge device 12 making it possible to achieve beneficial actions such as sound isolation coming from the impeller-motor device 10.
Sound is reduced at least by 25 dB with respect to a conventional fan (˜70 dB). Noise is an important issue for transformers. Noise reduction enables to place the transformers close to residential areas etc.
The separation of the impeller-motor device 10 and the fluid discharge device 12 also makes it possible to protect the moving parts, e.g., impeller-motor device 10, from harsh environmental conditions such as snow, rain, lightning, storm etc.
Flexibility on material, e.g., metal and/or composite, choice.
Robust construction of the cooling arrangement 20 with no moving parts.
High reliability because the cooling arrangement does not have tear and wearable components, and hence, much longer life than bladed fans can be expected.
The cooling arrangement 20 will not have dust deposition causing cleaning difficulties.
The cooling arrangement 20 can work in a wide range of weather temperatures (−40 C to +60 C).
The cooling arrangement 20 can replace the standard fans without making much modification.
For the OAEHEs such as radiators, the cooling arrangement 20 will not block the vertical fluid flow (natural convection). The cooling arrangement 20 can be placed beneath the existing OAEHEs to produce increased cooling range (forced convection), which enables increase in power rating of the existing transformer. Radiator ONAN and OFAN can be turned into ONAF and OFAF, respectively; by applying the cooling arrangement 20 below the OAEHE to achieve forced convection.
Since the impeller-motor device 10 is separated from the fluid discharge device 12 and located away from the transformer, constant fresh fluid will be circulated and hence, warming up of the fluid around the transformer is prevented.
The cooling arrangement 20 can enable a new design of OAEHEs with reduced footprint.
Two cooling arrangements 20 (one larger and one smaller) facing each other in a sandwich-like configuration for efficient cooling will enable higher and more homogeneous flow distribution.
Multiple cooling arrangements 20 can be fed from a powerful single impeller-motor device 10 via a fluid-duct branching system.
If needed, the funnel 15 or a flow director can be connected as a flow-guide, ensuring that all fluid passes through the OAEHE.
The overall weight of the transformer will be reduced, by improved cooling efficiency reducing external OAEHE size.
Oil required for transformer cooling can be reduced due to better external cooling efficiency.
Simple and easy manufacturing.
Reduced maintenance because most of the components are encapsulated, and personal risks during maintenance operation is eliminated.
It is safe for humans and/or animals.

It is to be noted that any feature of any of the aspects may be applied to any other aspect, wherever appropriate. Likewise, any advantage of any of the aspects may apply to any of the other aspects.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated. The use of “first”, “second” etc. for different features/components of the present disclosure are only intended to distinguish the features/components from other similar features/components and not to impart any order or hierarchy to the features/components.

It will be appreciated that the foregoing description and the accompanying drawings represent non-limiting examples of the method taught herein. As such, techniques taught herein are not limited by the foregoing description and accompanying drawings. Instead, the embodiments herein are limited only by the following claims and their legal equivalents.

1.-15. (canceled)

16. A cooling arrangement for cooling at least one oil-to-air external heat exchanger (OAEHE) in a transformer, the cooling arrangement comprises:
at least one impeller-motor device;
at least one fluid pipe; and
at least one fluid discharge device comprising a fluid inlet for receiving fluid from the at least one fluid pipe, and at least one fluid outlet arranged to produce an evenly distributed fluid flow towards the OAEHE,
the at least one impeller-motor device adapted to supply a fluid to the inlet of the at least one fluid discharge device via the at least one fluid pipe and cause the fluid to flow through the at least one fluid discharge device, and
the at least one impeller-motor device located in a housing at a distance of at least one meter from the at least one fluid discharge device.

17. The cooling arrangement according to claim 16, further comprising a plurality of fluid pipes that are adapted to supply fluid to a plurality of fluid discharge devices.

18. The cooling arrangement according to claim 16, wherein the fluid discharge device comprises at least one slit that is designed to be so narrow as to alter a recited physical property of the fluid stream by a recited amount due to the Bernoulli effect.

19. The cooling arrangement according to claim 16, wherein the at least one fluid discharge device comprises a cross-section that has a circular, oval, rectangular, or polygonal shape.

20. The cooling arrangement according to claim 16, wherein the at least one fluid discharge device is arranged in a funnel.

21. The cooling arrangement according to claim 21, wherein the funnel comprises round smooth borders at an inlet of the funnel to facilitate a Coandă effect, which mitigates edge turbulence and reduces pressure drop at the inlet of the funnel.

22. The cooling arrangement according to claim 16, wherein the housing is one or more of: sound shielded, thermally insulated, comprises thermally insulating material, humidity controlled, dustproof and/or sound absorbing.

23. The cooling arrangement according to claim 16, wherein the at least one fluid pipe comprises a thermally insulated material.

24. The cooling arrangement according to claim 16, further comprising a hose that is arranged to enhance and/or homogenize the supplied fluid.

25. The cooling arrangement according to claim 16, further comprising a second fluid discharge device.

26. The cooling arrangement according to claim 25, wherein the maximum cross-sectional dimension of the second fluid discharge device is smaller than the maximum cross-sectional dimension of the fluid discharge device.

27. The cooling arrangement according to claim 16, further comprising a visual device to verify the function of the at least one fluid discharge device.

28. Method performed by a cooling arrangement for cooling at least one oil-to-air external heat exchanger (OAEHE) in a transformer, the cooling arrangement comprising at least one impeller-motor device, at least one fluid pipe and at least one fluid discharge device comprising a fluid inlet for receiving fluid from the at least one fluid pipe, and at least one fluid outlet, the method comprising:
supplying a fluid flow into the at least one fluid pipe, using the at least one impeller-motor device;
transporting the fluid flow along the at least one fluid pipe to the inlet of the at least one fluid discharge device;
causing the fluid to flow through the at least one fluid discharge device; and
discharging the fluid flow through the at least one fluid outlet in a direction of the at least one OAEHE, the at least one impeller-motor device located in a housing at a distance of at least one meter from the at least one fluid discharge device.

29. The method according to claim 28, further comprising:
generating a filtered fluid flow to the at least one impeller-motor device;

30. The method according to claim 28, further comprising:
adding additional fluid flow to an axial region of the fluid discharge device with a hose or a second fluid discharge device to enhance and/or homogenize the supplied fluid flow.

31. A transformer comprising:
a oil-to-air external heat exchanger (OAEHE); and
a cooling arrangement for cooling the OAEHE, the cooling arrangement comprising:
at least one impeller-motor device;
at least one fluid pipe; and
at least one fluid discharge device comprising a fluid inlet for receiving fluid from the at least one fluid pipe, and at least one fluid outlet arranged to produce an evenly distributed fluid flow towards the OAEHE,
the at least one impeller-motor device adapted to supply a fluid to the inlet of the at least one fluid discharge device via the at least one fluid pipe and cause the fluid to flow through the at least one fluid discharge device, and
the at least one impeller-motor device located in a housing at a distance of at least one meter from the at least one fluid discharge device.

32. The cooling arrangement according to claim 31, further comprising a plurality of fluid pipes that are adapted to supply fluid to a plurality of fluid discharge devices.

33. The cooling arrangement according to claim 31, wherein the fluid discharge device comprises at least one slit that is designed to be so narrow as to alter a recited physical property of the fluid stream by a recited amount due to the Bernoulli effect.

34. The cooling arrangement according to claim 31, wherein the at least one fluid discharge device comprises a cross-section that has a circular, oval, rectangular, or polygonal shape.

35. The cooling arrangement according to claim 31, wherein the at least one fluid discharge device is arranged in a funnel.
